(19) United States
(12) Patent Application Publication
(10) Pub. No.: US 2014/0196090 A1
(43) Pub. Date: Jul. 10, 2014

(54) INFORMATION PROCESSING APPARATUS, INFORMATION PROCESSING METHOD, AND STORAGE MEDIUM

(71) Applicant: KABUSHIKI KAISHA TOSHIBA, Tokyo (JP)

(72) Inventors: Hideo Kataoka, Tokyo (JP); Takashi Nakamura, Musashino-shi (JP); Hideyuki Toma, Kodaira-shi (JP)

(73) Assignee: KABUSHIKI KAISHA TOSHIBA, Tokyo (JP)

(21) Appl. No.: 14/063,900

(22) Filed: Oct. 25, 2013

Related U.S. Application Data
(63) Continuation of application No. PCT/JP2013/058361, filed on Mar. 22, 2013.

(30) Foreign Application Priority Data
Jan. 4, 2013 (JP) 2013-000215

(51) Int. Cl. H04N 21/482; H04N 21/81

(52) U.S. Cl. CPC H04N 21/482; H04N 21/8133
USPC 725/43

(57) ABSTRACT

According to one embodiment, an information processing apparatus includes a first display controller, second display controller, and third display controller. The first display controller displays a program guide in a first area of a screen and program information about a program in a second area of the screen. The second display controller displays, in the first area, detailed information of the program information displayed in the second area. The third display controller displays, when detailed information about another program or another title is displayed in the first area, program information about the other program or the other title in the second area.

### CROSS REFERENCE TO RELATED APPLICATIONS

This application is a Continuation Application of PCT Application No. PCT/JP2013/058361, filed Mar. 22, 2013 and based upon and claiming the benefit of priority from Japanese Patent Application No. 2013-000215, filed Jan. 4, 2013, the entire contents of all of which are incorporated herein by reference.

### FIELD

Embodiments described herein relate generally to an information processing apparatus, an information processing method, and a storage medium which processes video contents of a television receiving apparatus and the like.

### BACKGROUND

Television receiving apparatuses have recently been increasing in the number of channels, whereby a wide variety of programs can be viewed. The programs can not only be viewed but also be recorded in a recording apparatus built in a television receiving apparatus or an external recording apparatus and viewed afterward. Recording apparatuses have been increasing in capacity and become capable of recording a lot of programs. Recent television receiving apparatuses can thus provide many viewable programs to users. The users select a program to view from a large number of programs in a program guide or recording list. For recording, the users also select a desired program from an electronic program guide.

Existing information processing apparatuses can provide users with a large amount of contents, whereas it has been difficult for the users to select contents therefrom.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram showing an overall configuration of an example of an information processing system including an information processing apparatus according to an embodiment.

FIG. 2 is a block diagram showing a configuration of a television receiving apparatus which is an example of the information processing apparatus according to the embodiment.

FIG. 3 is a plan view showing a configuration of a remote controller of the television receiving apparatus according to the embodiment.

FIG. 4 is a diagram showing an example of a cloud menu of the television receiving apparatus according to the embodiment.

FIG. 5 is a diagram showing an example of a media guide menu of the television receiving apparatus according to the embodiment.

FIG. 6 is a diagram showing an example of an electronic program guide of the television receiving apparatus according to the embodiment.

FIG. 7 is a diagram showing a configuration example of a program frame of the electronic program guide according to the embodiment.

FIG. 8 is a diagram showing an example of a change of display when selecting a program in the electronic program guide according to the embodiment.

FIG. 9 is a diagram showing an example of a function popup menu of the electronic program guide according to the embodiment.

FIG. 10 is a diagram showing an example of a program detail display of the electronic program guide according to the embodiment.

FIG. 11 is a diagram showing an example of a cast detail display of the electronic program guide according to the embodiment.

FIG. 12 is a diagram showing an example of a title detail display when a title is selected from the cast detail display of FIG. 11.

FIG. 13 is a diagram showing an example of a screen display when a software keyboard is superposed on the media guide menu according to the embodiment.

FIG. 14 is a diagram showing an example of a screen display when a search keyword is input by using the software keyboard of FIG. 13.

FIG. 15 is a diagram showing an example of a search result of a cross media search using the software keyboard of FIG. 13.

FIG. 16A is a diagram showing an example of the layer configuration of a screen for displaying the software keyboard of FIG. 13.

FIG. 16B is a diagram showing the example of the layer configuration of the screen for displaying the software keyboard of FIG. 13.

FIG. 17A is a diagram showing an example of a jump menu which is displayed when a blue color key is pressed during the display of the electronic program guide of FIG. 6.

FIG. 17B is a diagram showing the example of the jump menu which is displayed when the blue color key is pressed during the display of the electronic program guide of FIG. 6.

FIG. 17C is a diagram showing the example of the jump menu which is displayed when the blue color key is pressed during the display of the electronic program guide of FIG. 6.

FIG. 18 is a diagram showing an example of a screen display when “now” is selected during the display the jump menu of FIG. 17.

FIG. 19 is a diagram showing an example of a screen display when “channel jump” is selected during the display of the jump menu of FIG. 17.

FIG. 20A is a diagram showing an example of a screen display when “10 key jump” is selected during the display of a channel jump menu of FIG. 19.

FIG. 20B is a diagram showing an example of a screen display when “channel jump” is selected during the display of the channel jump menu of FIG. 19.

FIG. 20C is a diagram showing an example of a screen display when “recent channel jump” is selected during the display of the channel jump menu of FIG. 19.

FIG. 20D is a diagram showing an example of a screen display when “block jump” is selected during the display of the channel jump menu of FIG. 19.

FIG. 21 is a diagram showing an example of a display screen when “date and time” is selected during the display of the jump menu of FIG. 17C.

FIG. 22 is a diagram showing an example of a screen display when “related jump” is selected during the display of the jump menu of FIG. 17C.

FIG. 23A is a diagram showing an example of a channel mode menu which is displayed when a red color key is pressed during the display of the electronic program guide of FIG. 6.

FIG. 23B is a diagram showing the example of the channel mode menu which is displayed when the red color key is pressed during the display of the electronic program guide of FIG. 6.

FIG. 24A is a diagram showing an example of a view filter menu which is be displayed when a green color key is pressed during the display of the electronic program guide of FIG. 6.

FIG. 24B is a diagram showing the example of the view filter menu which is displayed when the green color key is pressed during the display of the electronic program guide of FIG. 6.

FIG. 25 is a diagram showing an example of color settings in the view filter menu of FIG. 24B.

### DETAILED DESCRIPTION

Various embodiments will be described hereinafter with reference to the accompanying drawings.

In general, according to one embodiment, an information processing apparatus includes a first display controller, a second display controller, and a third display controller. The first display controller displays a program guide in a first area of a screen and program information about a program in a second area of the screen. The second display controller displays, in the first area, detailed information of the program information displayed in the second area. The third display controller displays, when detailed information about another program or another title is displayed in the first area, program information about the other program or the other title in the second area.

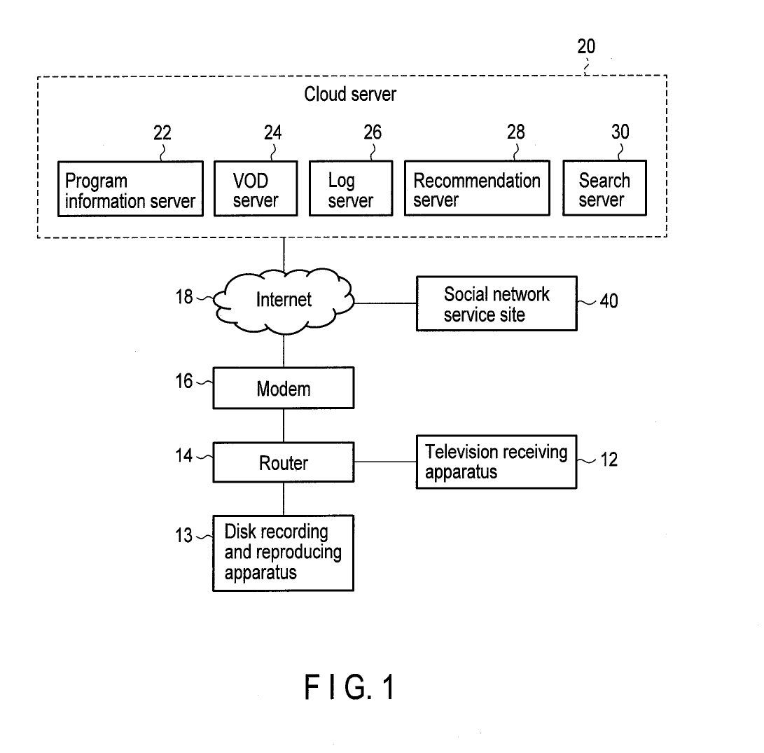

FIG. 1 is a block diagram showing an overall configuration of an example of an information processing system including an information processing apparatus according to the embodiment. Information processing apparatuses may include a television receiving apparatus, a personal computer having a television receiving function, and a disk recording and reproducing apparatus. The following description will be given by using a television receiving apparatus having a recording function as an example.

A television receiving apparatus 12 has a network function. The television receiving apparatus 12 is connected to a router 14 to constitute a home network along with a disk recording and reproducing apparatus 13 and the like. Note that the disk recording and reproducing apparatus 13 is not indispensable, and is connected according to need. A tuner-equipped personal computer and/or mobile terminals such as a smartphone and tablet may also be wirelessly connected to the router 14. The router 14 is connected to the Internet 18 via a modem 16. Although not shown, an external hard disk drive of the television receiving apparatus 12 can also be connected to the router 14.

A cloud server 20 providing cloud services and a social network service site 40 are also connected to the Internet 18. The cloud services provide services provided by a service provider company and links to functions of the television receiving apparatus 12 itself such as moving image playback. The cloud services can also be used to exchange program information with others or enjoy preferred moving images or shopping. The cloud server 20 includes a program information server 22 which transmits electronic program guide data (EPG data) to the television receiving apparatus 12, a video-on-demand (VOD) server 24 which transmits video contents to a user of the television receiving apparatus 12 according to a request from the user, a log server 26 which manages a history of behaviors (such as viewing, recording, playback, and the Internet shopping) of the television receiving apparatus 12 or each user of the television receiving apparatus 12, a recommendation server 28 which informs programs recommended for the television receiving apparatus 12 or each user of the television receiving apparatus 12 to the user, and a search server 30 which performs search processing according to a search request from a user of the television receiving apparatus 12 and transmits the search result to the user. Note that the electronic program guide data can also be transmitted to the television receiving apparatus 12 as multiplexed with television broadcast signals, instead of via the Internet 18. The program information server 22 therefore need not be provided. The VOD server 24 may include servers of a plurality of VOD service companies. When the television receiving apparatus 12 is used to perform viewing, recording, playback, the Internet shopping, and the like, the log server 26 automatically acquires the information via the Internet 18 and accumulates the information with respect to the television receiving apparatus 12 or each user of the television receiving apparatus 12. The log server 26 also stores information about programs recorded by the television receiving apparatus 12. The stored data shows preferences of the television receiving apparatus 12 or each user of the television receiving apparatus 12. The recommendation server 28 provides information about recommended programs and/or titles for the television receiving apparatus 12 or each user of the television receiving apparatus 12 based on the information stored in the log server 26. The search server 30 searches video contents (programs on the electronic program guide, programs in a recording list, and VOD video titles) stored in the cloud server 20 based on a keyword transmitted from the television receiving server 12 for contents associated with the keyword. The servers 22, 24, 26, 28, and 30 need not be physically independent ones. The cloud server 20 may be conceptually divided by function.

The social network service site 40 has various types of information posted by a lot of users. The information includes reputations about video contents and information about contents recommendable to others. When the cloud server 20 searches for contents, the information of the social network service site 40 can also be used to perform various searches.

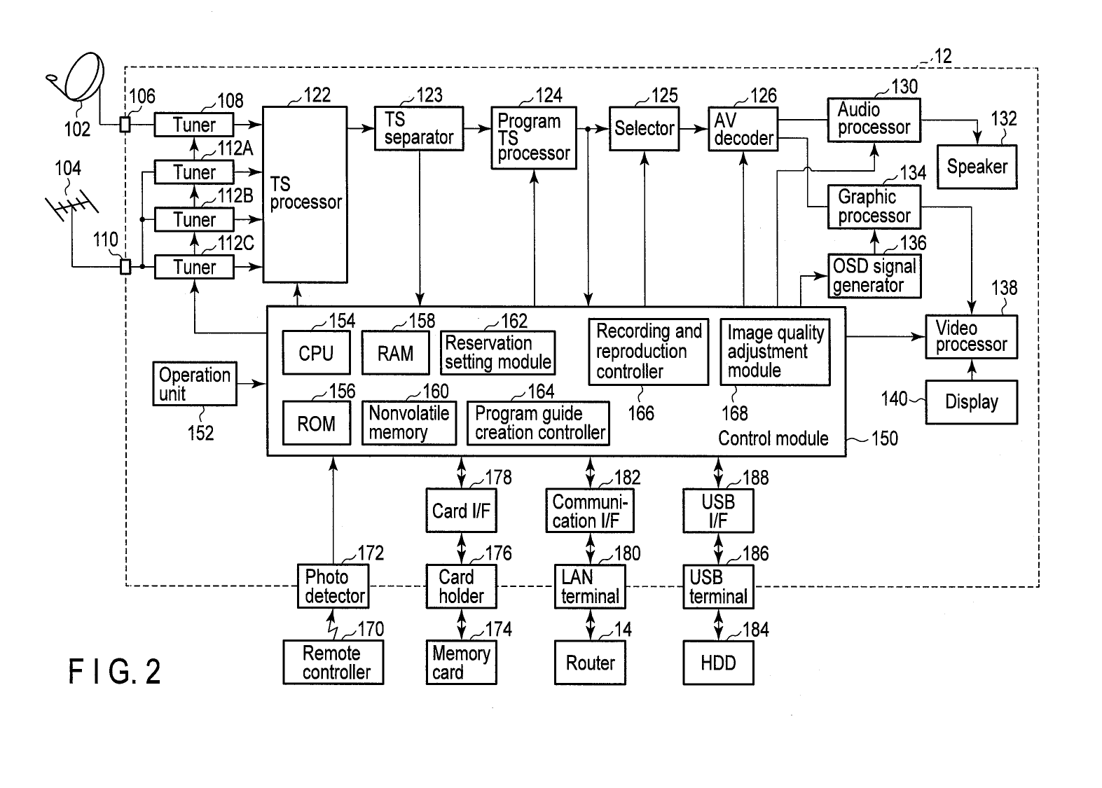

FIG. 2 is a block diagram of the television receiving apparatus 12. Digital satellite broadcast signals received by a BS/CS digital broadcast reception antenna 102 for receiving are supplied to a tuner 108 for satellite digital broadcasting via an input terminal 106, whereby the broadcast signal of a desired channel is tuned to.

Digital terrestrial television broadcast signals received by a terrestrial broadcast reception antenna 104 are supplied to digital terrestrial broadcasting tuners 112A, 112B, and 112C via an input terminal 110, whereby the broadcast signals of desired channels are tuned to.

Pay-TV broadcast signals are scrambled. While four tuners are shown in the diagram, it will be understood that additional tuners may be provided. The tuners may be three or less in number. The broadcasting is not limited to the reception of radio waves propagating through the air, and may be such that programs distributed from broadcasting stations through a network like a cable TV and an IP (Internet Protocol) network can be received.

The signals of the broadcast programs received by the tuners 108, 112A, 112B, and 112C are input to a TS processor 122 which functions as a remultiplexing module, whereby TSs (transport streams) of the plurality of channels (CHs) are remultiplexed into a TS.

The TS output from the TS processor 122 includes TS packets of a plurality of channels multiplexed in a time division manner. For example, with 4-CH inputs, the TS processor 122 multiplexes the packet arrays in a time division manner at a rate five times the input rate and outputs the multiplexed TS. Control information packets are embedded in the packet array of the multiplexed TS. The control information packets convey control information including time stamp information and packet array order information about channel packets for each multiplexed channel.

The TS remultiplexing method is not limited to the method described here, and various methods may be used. The TS remultiplexed by the TS processor 122 is transmitted to a TS separator 123. The TS separator 123 separates ECM (Entitlement Control Message) that is encryption information and EIT (Event Information Table) that is a table describing event information such as a program name, casts, and a start time from the signals of the broadcast programs. The TS separator 123 also separates and supplies EPG (Electric Program Guide) data and the like to a control module 150. The TS of the broadcast programs is transmitted to a program TS processor 124.

All the operations of the television receiving apparatus 12 including the foregoing various operations are controlled by the control module 150 in a centralized manner. The control module 150 includes a CPU (central processor) 154. The control module 150 receives operation information from an operation unit 152 which is arranged on the front of a cabinet, or receives operation information that is transmitted from a remote controller 170 and received by a photo detector 172, and controls each component to reflect the content of the operation.

The control module 150 includes at least a ROM (read only memory) 156 which stores a control program for the CPU 154 to perform, a RAM (random access memory) 158 which provides a work area for the CPU 154, a nonvolatile memory 160 which stores various types of setting information, control information, EPG data, and the like, a reservation setting module 162, a program guide creation controller 164, a recording and reproduction controller 166, and an image quality adjustment module 168. The program guide creation controller 164 creates an electronic program guide based on EPG data acquired in advance via broadcast signals, a network, and the like, and displays the electronic program guide on-screen as a video image. The EPG data is usually acquired via broadcast signals. The EPG data is separated from the broadcast signals received via the antennas by controlling the tuners 108, 112A, 112B, and 112C. However, the EPG data may also be obtained from the Internet 18 via a communication I/F 182, a LAN terminal 180, and the router 14. The EPG data is stored in the nonvolatile memory 160. As a result, the user can select a desired program from the electronic program guide displayed as a video image, and view the program or make a recording reservation etc. The reservation setting module 162 makes recording and viewing reservations for broadcast programs. The recording and reproduction controller 166 performs programmed (or timer) recording of programs by performing recording based on reservation information (or timer information) of the reservation setting module 162.

The control module 150 is connected to a card holder 176 via a card I/F 178. A memory card (IC card) 174 can be mounted on the card holder 176. Consequently, the control module 150 can perform information transmission with the memory card 174 mounted on the card holder 176 via the card I/F 176. For example, the memory card 174 records contract information about a broadcast reception contract or the like.

The control module 150 can perform information transmission with the disk recording and reproducing apparatus 13, a personal computer, and the like that are connected to the router 14. The control module 150 is also connected to the Internet 18 via the router 14 and the modem 16.

The control module 150 is connected to a USB terminal 186 via a USB I/F 188. The control module 150 can thus perform information transmission with a USB-compatible hard disk drive (HDD) 184 connected to the USB terminal 186 via the USB I/F 188. Note that the hard disk drive is not limited to an external one, and may be a built-in. A built-in hard disk drive is connected to the control module 150 via a not-shown ATA interface or the like. The number of external hard disk drives is not limited to one. A plurality of hard disk drives may be connected. The hard disk drive may even be a drive that is connected to the router 14 via a LAN.

The program TS processor 124 performs descrambling and the like on program streams of pay programs. Descrambling keys are generated by the control module 150. The control module 150 generates a key by using information included in ECM, the contract information in the memory card 174, and the like. Program streams of free programs are passed without descrambling.

The program TS output from the program TS processor 124 is supplied to a selector 125 and the recording and reproduction controller 166 in the control module 150. The selector 125 selects the TS of a program the user is going to view, and supplies the TS to an AV decoder 126. Video data included in video packets in the program TS has been encoded by, for example, an MPEG (Moving Picture Expert Group) method, AVC (Advanced Video Coding) method, or the like. Audio data in audio packets has been encoded by, for example, a PCM (Pulse Code Modulation) method, Dolby method, MPEG method, or the like. The AV decoder 126 separates the video packets and audio packets of the program, and decodes the data in the packets according to the respective methods.

The decoded audio data is adjusted in volume and sound quality and converted into an analog audio signal by an audio processor 130 before supplied to a speaker 132.

The decoded video data is supplied to a graphics processor 134. The graphics processor 134 has a function of superposing an OSD signal generated by an OSD (on screen display) signal generator 136 on the digital video signal supplied from the AV decoder 126 and outputting the resultant. The graphics processor 134 can also selectively output the output video signal of the AV decoder 126 and the output OSD signal of the OSD signal generator 134, and output the two outputs in combination to constitute respective halves of the screen.

The digital video signal output from the graphics processor 134 is supplied to a video processor 138. The video processor 138 converts the input digital video signal into an analog video signal of a format displayable on a display 140 comprising an LCD panel, a plasma display panel, an SED panel, or the like before output to the display 140 for video display. The video processor 138 also adjusts image quality, color tone, a display scale, the number of scanning lines, resolution, and the like. Adjustment and control data to the audio processor 130 and the video processor 138 is supplied from the control module 150.

The recording and reproduction controller 166 can supply the program TS from the program TS processor 124 to the hard disk drive 184 via the USB terminal 186 and/or to the disk recording and reproducing apparatus 13 via the communication I/F 182, the LAN terminal 180, and the router 14. If the hard disk drive 184 has a large capacity, all the broadcast programs of a designated channel may be recorded for several days without individual designation of programs to be recorded. The disk recording and reproducing apparatus 13 can reproduce a removable disk such as a DVD and a BD, or perform signal recording on such disks. As shown in FIG. 1, the disk recording and reproducing apparatus 13 is connected to the television receiving apparatus 12 via the home network. The disk recording and reproducing apparatus 13 can function as a home server.

The control module 150 includes the program guide creation controller 164. The program guide creation controller 164 creates an electronic program guide about future programs including the current ones based on the EPG data. If all the broadcast programs of a designated channel are being recorded for several days, the program guide creation controller 164 may connect and manage a program guide about the programs broadcast in the past, already stored in the hard disk drive 184, a program guide about the program being currently broadcast, and a program guide about programs in the future (approximately one month) by using the EPG data on the past, present, and future programs.

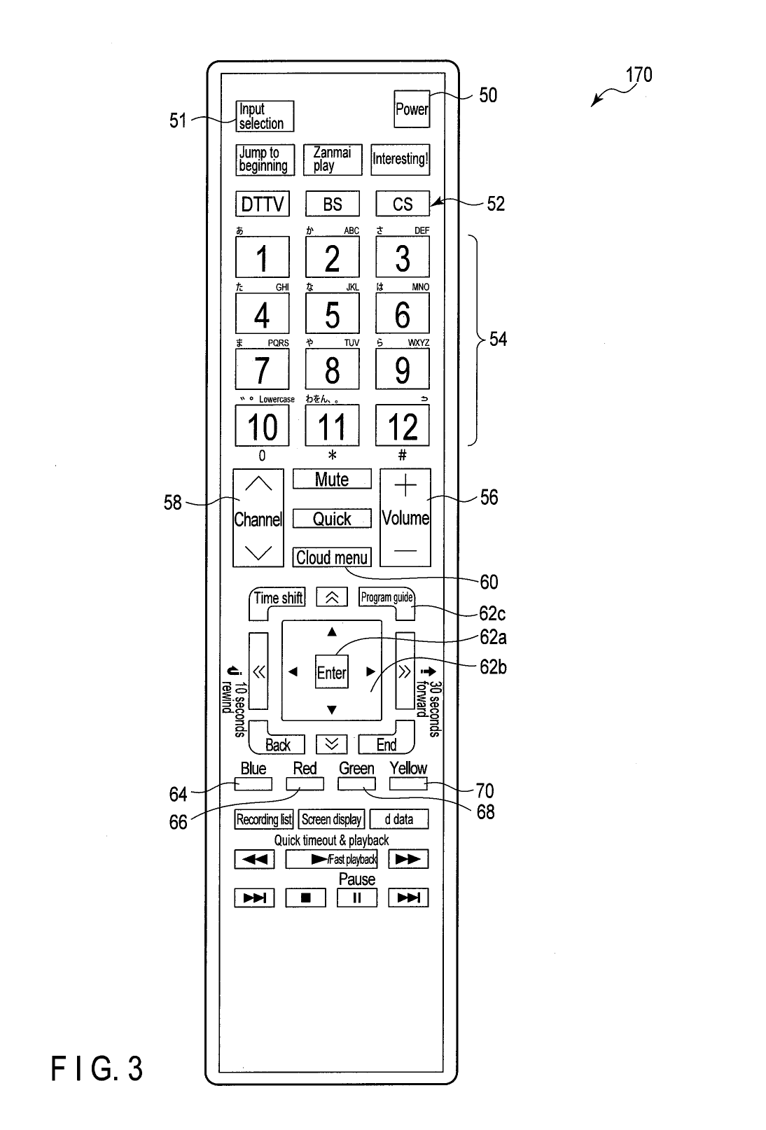

FIG. 3 is a plan view showing an appearance of the remote controller 170. The remote controller 170 includes at least a power key 50, an input selection key 51, DTTV, BS, and CS broadcast selection keys 52, direct channel selection keys 54, a channel up/down key 58, a volume control key 56, a cloud menu key 60, multi keys 62c, a cursor key 62b, an enter key 62a, a color key (blue) 64, a color key (red) 66, a color key (green) 67, and a color key (yellow) 70.

The cursor key 62b can be pressed in top, bottom, left, and right, four positions. A cursor can be shifted up, down, left, or right within the screen according to the pressed position. A shift refers to a minimum unit of movement, such as a movement to the next button in a menu or to the next program frame on an electronic program guide. The multi keys 62c can be pressed in a total of eight positions including top, bottom, left, right, and diagonals. When a cursor is displayed, any one of the top, bottom, left, and right keys can be pressed to make the cursor jump in the up, down, left, or right direction. The diagonal keys can be pressed to make key operations equivalent to four keys “time shift,” “program guide,” “end,” and “back.” A jump refers to a cursor movement in a greater unit than a shift, or a page switch to another page. A cursor jump and a page switch are thus synonymously used.

When the user makes a key operation on the multi key 62c “program guide” of the remote controller 170, the television receiving apparatus 12 can display an electronic program guide on the display 140. The electronic program guide is created by the program guide creation controller 164 based on the EPG information that is program information obtained in advance via broadcast signals, a network, or the like. When the user makes a key operation on a recording list key of the remote controller 170, the television receiving apparatus 12 can display a list of recorded programs on the display 140.

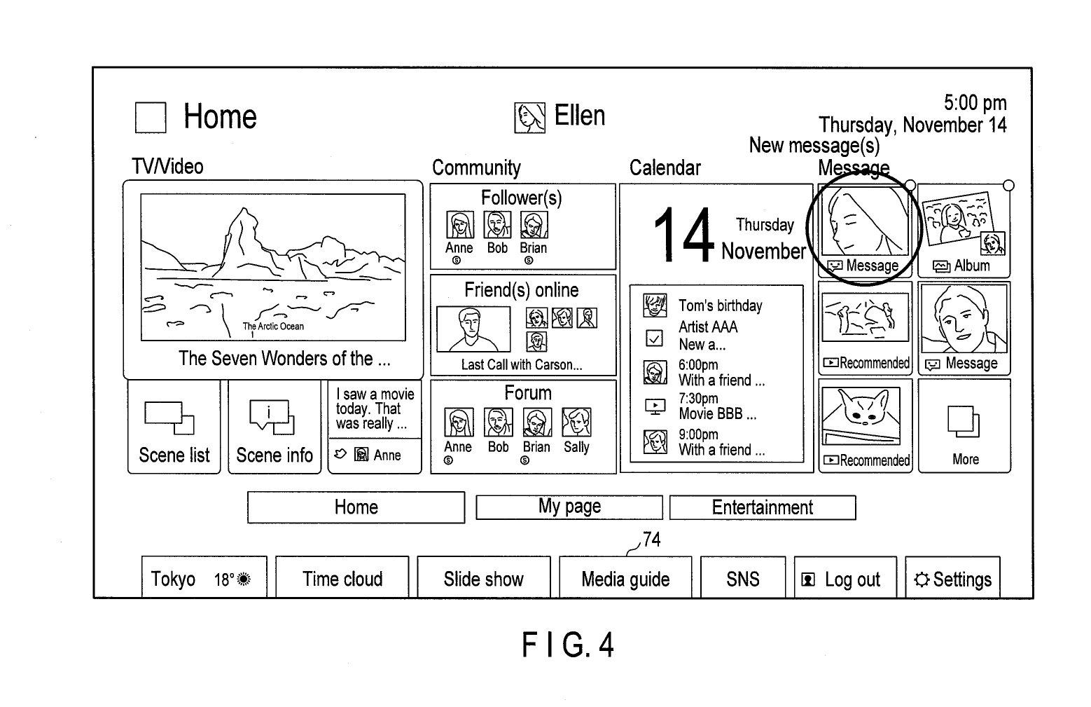

Next, an operation example of the television receiving apparatus 12 in the information processing system having such a configuration will be described. When the cloud menu key 60 of the remote controller 170 is pressed during viewing of a television program, playback of a recorded program, or viewing of a VOD video title, a cloud menu screen such as shown in FIG. 4 is displayed. The user may press the cloud menu key 60 when he/she wants to use a cloud service. The cloud menu is a list of various cloud services. Since the menu items vary according to the available cloud services, the cloud menu of FIG. 4 is just an example. The cloud menu includes a window of a television program or, when using a VOD service, a video title being currently viewed or reproduced. Selection buttons of various services include a media guide button 74. When the cloud menu screen is displayed, a cursor appears on any one of the menu items (buttons). According to operations on the cursor key 62b of the remote controller 170, the cursor moves to each menu item. When the enter button 62a is operated, the menu item is selected.

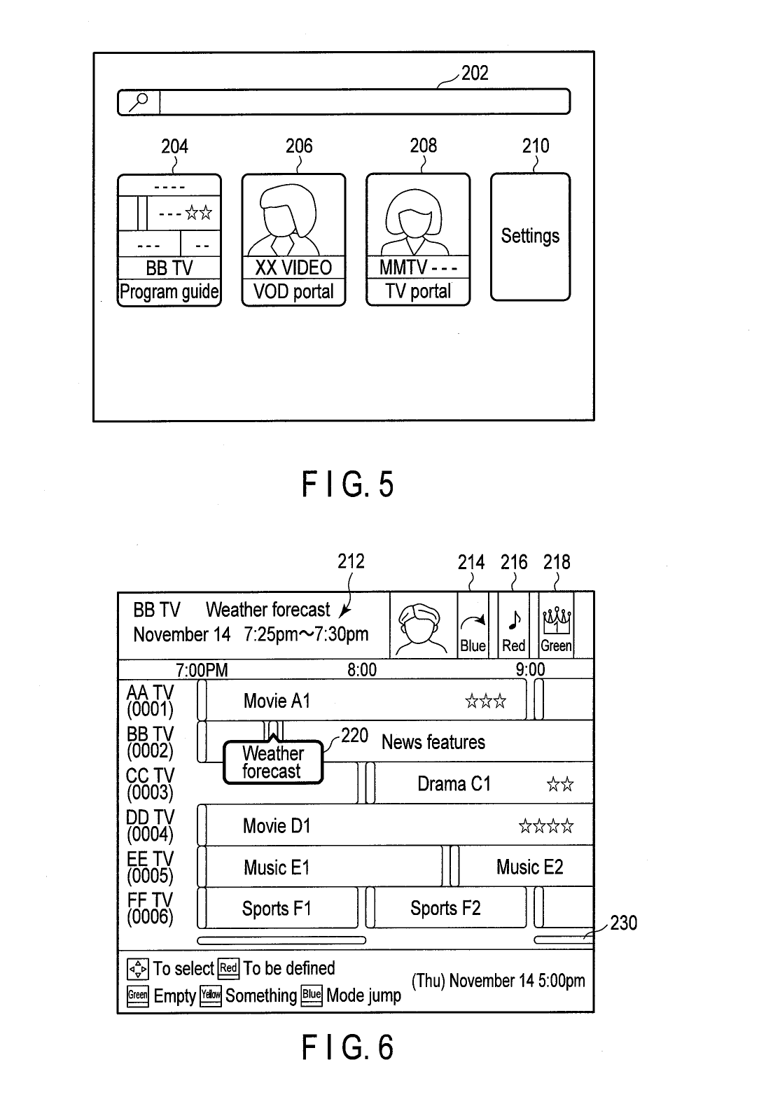

As described above, the television receiving apparatus 12 can select programs from a lot of channels, record a lot of programs, and view a lot of video titles from the VOD server 24. It is thus desired to efficiently and accurately select a program or title to view from such a large number of programs and titles (which may be referred to collectively as video contents). The present embodiment provides a media guide menu for efficiently and accurately searching for various video contents. If a media guide button 74 of the cloud menu is selected, a media guide menu such as shown in FIG. 5 is displayed.

The media guide menu includes a cross media search bar 202, a program guide window 204, a VOD portal window 206, a TV portal window 208, and a setting window 210. The cross media search bar 202 is an area for inputting a keyword when searching for television programs, recorded programs, VOD video titles, and the like viewable by the television receiving apparatus 12. The program guide window 204 enlarges and displays a part of an electronic program guide with a currently-viewed television program in the center. The VOD portal window 206 displays the title thumbnail and the VOD service company name of VOD contents associated with the currently-viewed television program or video title. The TV portal window 208 displays the title thumbnail and the channel name of a television program or recorded program recommended to the user. The setting window 210 is a portal button for various setting menus.

FIG. 6 shows an example of the electronic program guide that is displayed when the program guide window 204 of the media guide menu is selected. The electronic program guide is also displayed when the multi key 62c “program guide” of the remote controller 170 is pressed.

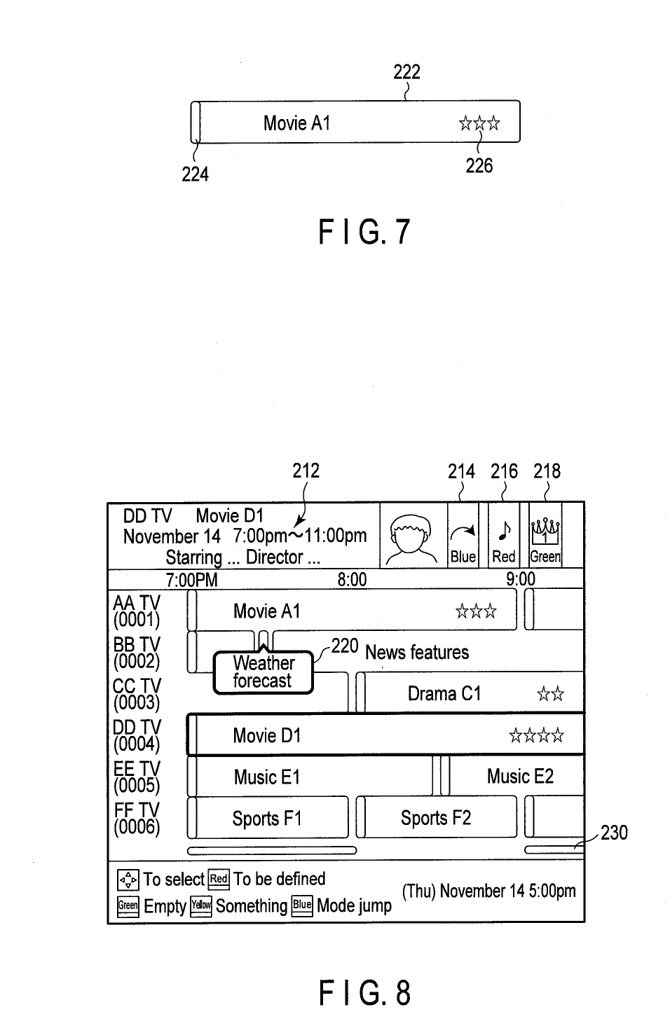

The vertical direction of the electronic program guide shown in FIG. 6 indicates channels. The horizontal direction indicates time (starting at the current time). Program frames representing respective programs are arranged in a matrix. For example, program frames of eight channels (six channels are shown for the sake of convenience) for four hours (two hours and a half are shown for the sake of convenience) are arranged in a matrix. FIG. 7 shows an example of a program frame. A horizontally long program frame 222 having a length according to the duration of the program includes a vertical color bar 224 at the head of the frame before the program name, and a predetermined icon 226 such as star marks at the end of the frame after the program name. The color bar 224 is colored according to the genre of the program. For example, the color bar 224 is displayed in red for a sport, blue for a drama, and green for a movie. Note that the genres may be displayed by genre icons, not necessarily by color bars. The predetermined icon 226 can express various types of information. For example, the degree of recommendation may be expressed by the number of stars based on information from the recommendation server 28.

The genre coloring and the display mode of the predetermined icon 226 can be further controlled by a view filter function to be described later. More specifically, when the color bar 224 expresses a genre, different colors may be assigned. The color bar 224 may express information other than genres. The predetermined icon 226 may express information from the cloud server 20 other than the recommendation server 28.

If the number of channels is more than six, the multi keys 62c can be pressed up/down to switch pages up/down and make the cursor jump, whereby a program guide of channels other than the group of channels currently displayed can be displayed. Similarly, to view a program guide of a time zone other than the currently displayed time zone, the multi keys 62c can be pressed left/right to switch pages left/right and make the cursor jump, whereby the program guide of the time zone other than the currently displayed time zone can be displayed.

Program frames of 10 minutes or less have too small a width to display a program name. Program frames of 10 minutes or less are displayed as simple vertical bars, and a popup appears when the cursor is located thereon.

The electronic program guide is arranged so that the array of program frames (so-called program guide) comes to the center. The names and channel numbers of the television stations are displayed on the left end of the program guide, and a time scale on the top end. Referring to the channel numbers, a channel number can be directly input by using the direct channel selection keys 54 to jump to a program guide of the desired channel.

A title information field 212 and a defined icon field 219 of blue, red, green, three color keys are horizontally arranged in the top margin of the program guide (corresponding to several rows of program frames). The title information field 212 displays program information about the program on which the cursor is located in the program guide (the thick-framed program frame in FIG. 6). The program information includes the name of the television station, the program name, the broadcast date and time, and a thumbnail of the program. FIG. 6 shows a case where the cursor is located on the program of a broadcast station (BB TV) from 7:25 p.m. to 7:30 p.m. with a popup program frame. When the cursor is moved, as shown in FIG. 8, the program information displayed in the title information field 212 also changes to the program information of another broadcast station (DD TV) from 7:00 to 11:00 p.m. In such a manner, as the cursor is moved and located on the program frame of another program, the display of the title information field 212 changes accordingly.

Various functions are assigned to the color keys of the remoter controller 170 according to situations. The defined icon field 219 is provided on the upper right of the program guide (in the right of the top margin) to inform the user of the currently assigned functions in an easy-to-understand manner. Here, blue, red, and green color key icons 214, 216, and 218 for displaying the types and setting states of functions settable by the blue, red, and green, three color keys are displayed. The color key icons 214, 216, and 218 will be described in detail later.

A time zone line marker 230 indicating the remaining time of the currently viewed program or a recording-programmed time zone is displayed on the bottom end of the program guide. Messages describing the functions of the color keys are displayed below the time zone line marker 230.

The electronic program guide has only to include a two-dimensional array of times and channels. The vertical and horizontal arrangements may be inverse to FIG. 6. Specifically, the channels may be arranged in the horizontal direction and the time the vertical direction. The number of channels and the specific figures of the times may be configured to be freely settable by the user.

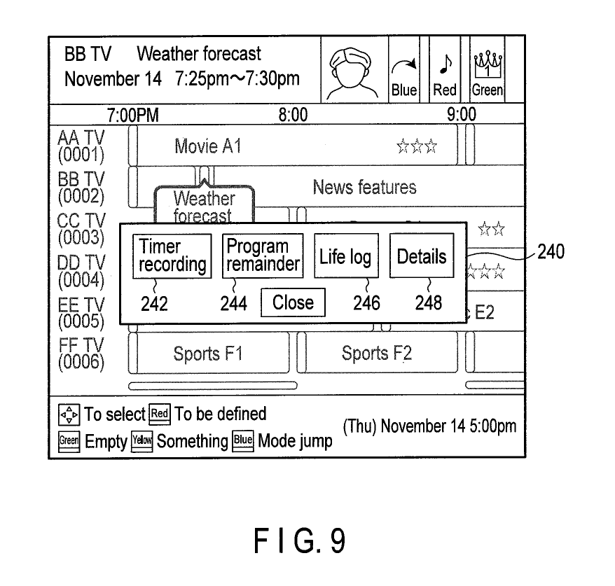

If the enter key 62a is pressed during the display of the electronic program guide of FIG. 6 or 8, the program on which the cursor is located at the point in time is selected, and a function popup menu 240 such as shown in FIG. 9 is displayed. The function popup menu 240 includes a timer recording button 242, a program remainder button 244, a life log button 246, and a detail button 248. When the buttons are selected, a menu of the respective corresponding functions is displayed.

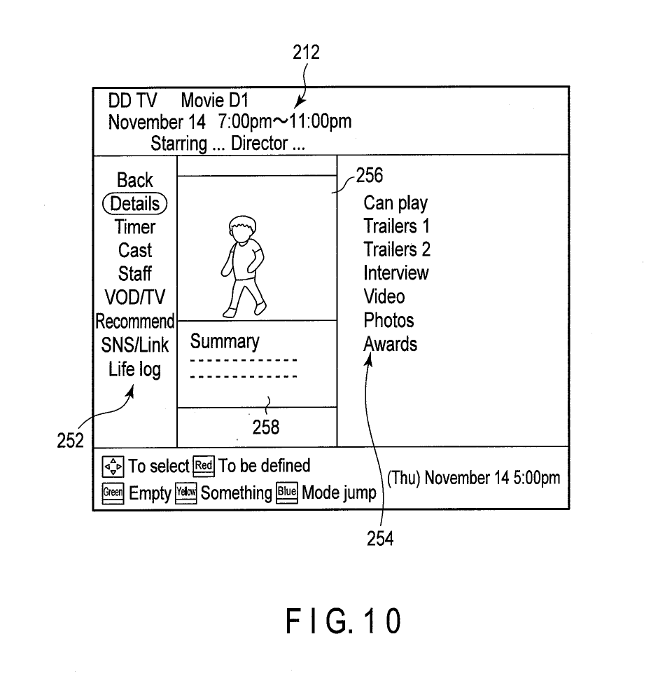

If the detail button 248 is selected, a program detail screen such as shown in FIG. 10 is displayed. The program detail screen has the same layout as that of the screen of the electronic program guide. The same title information field 212 as the title information field 212 of the electronic program guide in FIG. 6 or 8 is displayed on the top margin. In the program detail screen of FIG. 10, various types of detailed information are displayed instead of the array of program frames of the electronic program guide in FIG. 6 or 8. The detailed information includes a select button field 252 for selecting the type of details. The button field 252 includes a back button, a detail button, a timer button, a cast button, a staff button, a VOD/TV button, a recommendation button, an SNS/link button, and a life log button. If the detail button in the select button field 252 is selected, program details 258 including a thumbnail and a summary of the program are displayed next to the select button field 252. A related information list 254 is displayed next thereto. The related information list 254 includes a “can play” button, a trailers1 button, a trailers2 button, an interview button, a video button, a photo button, and an award button.

If the timer button in the select button field 252 is selected, information about the programmed recording of the program is displayed.

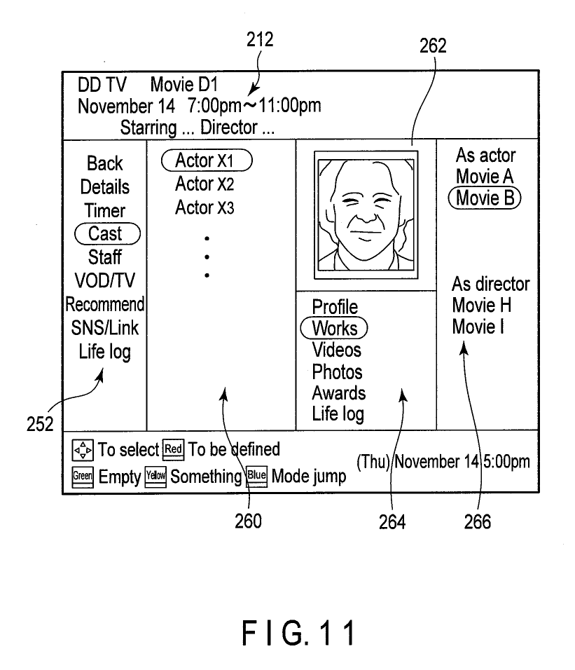

If the cast button in the select button field 252 is selected, a person detail screen such as shown in FIG. 11 is displayed. The person detail screen has the same layout as that of the screen of the electronic program guide. The same title information field 212 as the title information field 212 of the electronic program guide in FIG. 6 or 8 is displayed on the top margin. If the staff button in the select button field 252 is selected, a person detail screen is similarly displayed. In the cast detail screen of FIG. 11, various types of detailed information are displayed instead of the array of program frames of the electronic program guide in FIG. 6 or 8. The detailed information includes the select button field 252 for selecting the type of details. An actor list 260 is displayed next to the select button field 252 instead of the program details 258 and the related information list 254 of FIG. 10. If an actor in the actor list 260 is selected, the actor's portrait 262, the actor's profile 264, and the actor's related information list 266 are displayed next to the actor list 260. The actor's related information list 266 includes a list of titles in which the actor appears as an actor, and a list of titles in which the actor takes part as a staff member (for example, director).

The title information field 212 at the top of the screen does not change even if the program detail screen (FIG. 10) changes to the person detail screen (FIG. 11). More specifically, even if the detailed display of the program selected in the electronic program guide in the state of FIG. 8 changes to the detailed display of a person related to the program, the title information field 212 continues displaying the program information about the program selected in the electronic program guide in the state of FIG. 8.

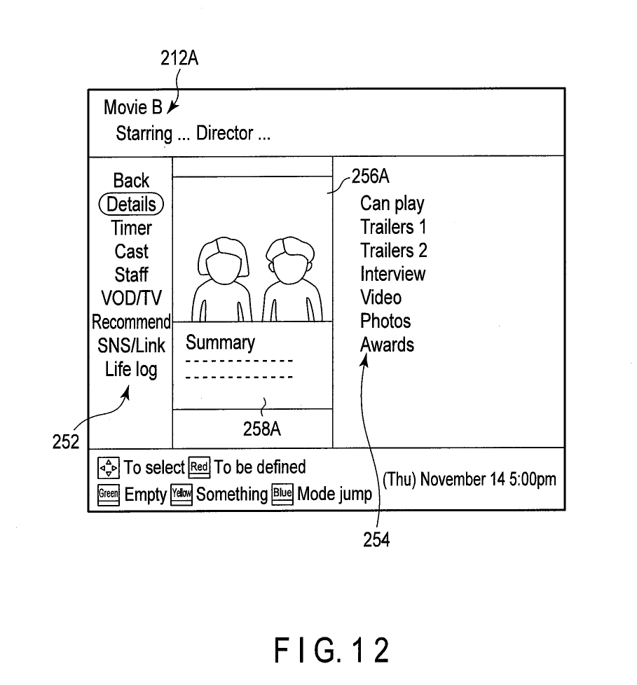

However, if another program or title related to the person is selected in the person detail screen of FIG. 11, the person detail screen changes to the detail screen of the another program or title and the title information field 212 at the top of the screen also changes to information about the another program or title program as shown in FIG. 12. It will be understood that the thumbnail 256A and the summary 258A also change to ones corresponding to the another program or title. In such a manner, while searches originating from a program are being made with the layout of the electronic program guide maintained, the title information field continues displaying the information about the program.

If the VOD/TV button, the recommendation button, the SNS/link button, or the life log button in the select button field 252 is selected, a VOD list or a rebroadcasting list of the program, a list of programs recommended to the user, a list of programs much talked about in an SNS, or the user's operation history method is similarly displayed. Such detail display screens have the same layout as that of the screen of the electronic program guide. The same title information field 212 as the title information field 212 of the electronic program guide in FIG. 6 or 8 is displayed on the top margin. The contents of the title information field 212 do not change even if the program detail screen (FIG. 10) changes to another detail screen.

Conventionally, electronic program guides can be used to search for related information about programs. For example, originating from a program, information about casts of the program, information about programs related to the program, information about programs recommended to the audience of the program, and the like can be searched for. If searches are continued like something related to something related to . . . and so on, it becomes difficult to recognize what program the current search is based on. This matters little when searching for general moving image contents. However, with television programs and the like where there is detailed information such as cast information and related program information about each individual title, it is more user-friendly if the search results can be comprehended in units of programs.

In view of this, in the present embodiment, as shown in FIGS. 10 to 12, the title information field 212 is arranged on top of the user interface for searching for program and title details, and the program or title displayed in the field is used as the origin of searches. The areas below the title information field 212 display detailed information about the result of a search according to the origin. If the title information field 212 changes from a program A to a program B, the lower areas also change to detailed information about the program B, not detailed information about the program A. If a program is selected on the electronic program guide, the program information about the selected program is displayed in the title information field.

Program information is usually ranked as a piece of detailed information and displayed in an accessory position. For example, if a cast is selected, program information about a program in which the cast appears is displayed in the title information field 212. In such a case, which program has originated the search becomes unidentifiable.

According to the present embodiment, the originating keyword continues being placed in the title information field 212. The title information field 212 remains unchanged as long as the lower areas continue displaying pieces of information associated with the same title information. The user interface is consistent. In other words, ordinary user interfaces have a hierarchical structure and descend hierarchically as searches advance. The user interface of the present embodiment is managed in a one-level structure at the program or title level. As a result, search results in units of titles can be provided by easier operability.

Tables 1 show another example of program detail information.

TABLE 1

| Column 1 | Column 2 | | Column 3 | Column 4 |
|---|---|---|---|---|
| Buttons | Functions | | Details | Details |
| Detail | Thumbnail | | (None) | (None) |
| | Synopsis | | | |
| | Award | | | |
| | Video | | | |
| | Photo | | | |
| | Rating | | | |
| | Bookmark | | | |
| | Like! | | | |
| | AD | | | |
| | CSP icons (VUDU, CinemNow) | | | |
| | Share (### create message) | | | |
| | Lifelog (watched) list | Popup | | |
| | Lifelog (can play) list | Popup | | |
| | Lifelog (recorded) list | Popup | | |
| Timer | View | Popup | (None) | (None) |
| | Rec | Popup | | |
| | Every week/etc | Popup | | |
| | Timer cancel | Popup | | |
| Buttons | Functions | | Details | Details |
| Cast | Names | | Personal detail | Program list |
| | Names | | | |
| Staff | Names | | Personal detail | Program list |
| | Names | | | |
| VOD/TV | Search result | CSPs/price | (None) | (None) |
| | | Date/Time/CH | | |
| Recommend | For you | | Program list | (None) |
| | Related | | Program list | (None) |
| | From friends | | Program list | (None) |
| | Social Buzz (before) | | Program list | (None) |
| | Social Buzz (now) | | Program list | (None) |
| | Social Buzz (future) | | Program list | (None) |
| SNS/Links | Twitter TL/post | | | |
| | Facebook TL/post | | | |
| | TSB chats TL/post | | | |
| | Shopping | | | |
| | Search photo | | | |
| | Search video | | | |
| | Search WWW | | | |

Table 2 shows an example of the relationship between person detail information and the program detail information.

TABLE 2

| | |
|---|---|
| Program detail | Personal detail |
| Thumbnail | Thumbnail |
| Synopsis | Profile |
| Award | Award |
| Video | Video |
| Photo | Photo |
| Rating | |
| Bookmark | |
| Like! | |
| AD | |
| Cast | Similar |
| Staff | |
| SHARE message | SHARE message |
| TV schedule | Works |
| VOD | |
| Recommend (for you) list | |
| Recommend (related) list | |
| Recommend (from friends) list | |
| Lifelog (watched) list | Lifelog (watched) |
| Lifelog (can play) list | Lifelog (can play) |
| Lifelog (recorded) list | Lifelog (recorded) |
| SNS | SNS |
| Link | Link |
| Shopping | Shopping |
| Social Buzz (before) | |
| Social Buzz (now) | |
| Social Buzz (future) | |

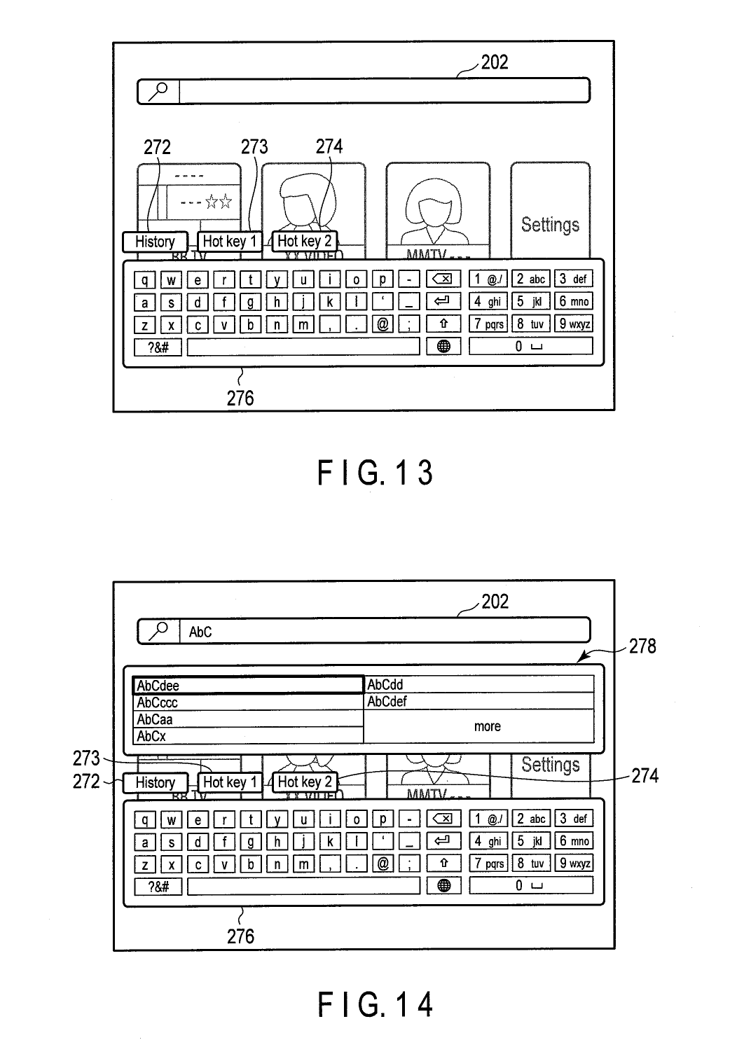

Next, the cross media search bar 202 will be described. If the cursor is moved to the cross media search bar 202 during the display of the media guide menu such as shown in FIG. 5, a software keyboard 276, a history button 272, a first hotkey button 202, and a second hotkey button 274 such as shown in FIG. 13 are displayed. The cross media search bar 202, the software keyboard 276, the history button 272, the first hotkey button 273, and the second hotkey button 274 are in the same layer, and the cursor can be freely moved therebetween.

In such a state, a search keyword can be input by moving the cursor to the software keyboard 276 and selecting characters one by one. When characters are input from the software keyboard 276, the input characters are displayed in the cross media search bar 202 in order. At the same time, keywords are predicted based on the input character string, and a keyword candidate list 278 such as shown in FIG. 14 is also displayed. Keywords that include the input character string and have been used in the past are listed as candidates.

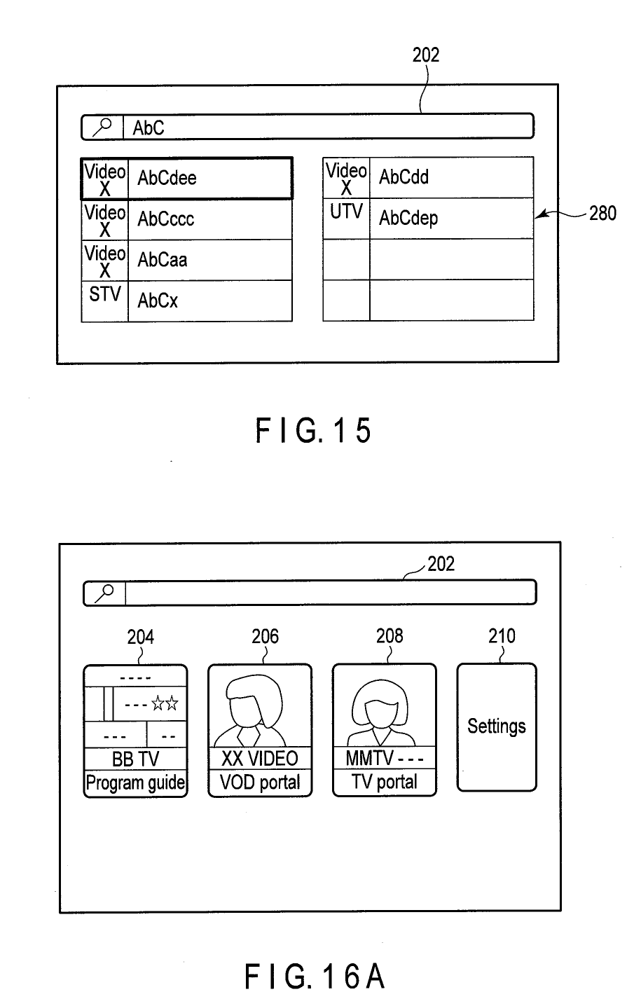

When a candidate is selected from the keyword candidate list 278, the selected keyword is displayed in the cross media search bar 202. At the same time, the keyword is transmitted to the search server 30 in the cloud server 20, whereby contents are searched for based on the keyword. The search server 30 searches broadcast programs in the electronic program guide, recorded programs recorded in the HDD 184, and video titles owned by the contracted VOD server 24 based on the keyword to detect programs and titles related to the keyword, and returns the search result to the television receiving apparatus 12. FIG. 15 shows a search result display screen. The search result display screen includes the cross media search bar 202 and a search result list 280. In the case of a television program, the search result list 280 includes the name of the broadcast station and the name of the program. In the case of a video title, the search result list 280 includes the name of the VOD service company and the name of the title.

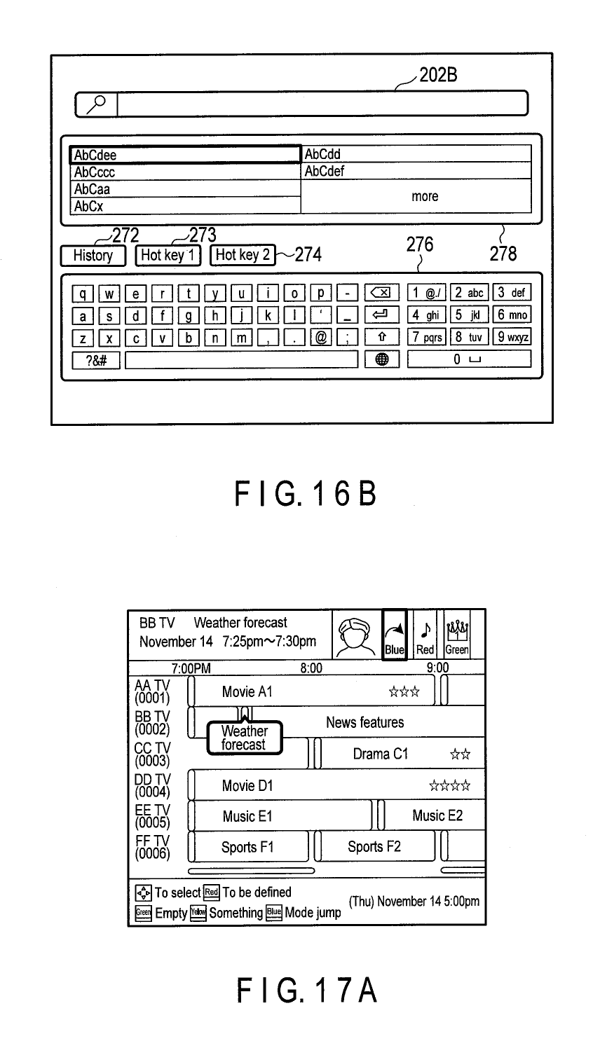

FIGS. 16A and 16B show a display example of the software keyboard 276. The software keyboard 276 is included in a layer-2 above a layer-1 including the media guide menu shown in FIG. 16A. The software keyboard 276 is thus superposed on the medium guide menu. As shown in FIG. 16B, the layer-2 includes not only the software keyboard 276 but also a cross media search bar 202B, the keyword candidate list 278, the history button 272, the first hotkey button 273, and the second hotkey button 274. The cursor key 62b of the remote controller 170 can be pressed to move the cursor only between the buttons in the same layer. To move the cursor to a different layer, the enter button 62a needs to be pressed to close the active layer. The cross media search bar 202 in the layer-1 and the cross media search bar 202B in the layer-2 are different display components, but arranged in the same position. When the layer-1 and the layer-2 are superposed, the cross media search bars can thus be recognized as if lying in the same layer, and are displayed as the same component.

When moving a cursor over an ordinary software keyboard to input characters, there is a character input screen layer on which a software keyboard layer is superposed. After the selection of characters, the software keyboard layer is closed, and the characters are input to a search keyword field in another layer and used for a search. In such a manner, a keyboard typically constitutes a layer by itself while a character input field is in another layer. Since the cursor cannot be moved to another layer without once closing the active layer, it takes a long time to operate. In contrast, according to the present embodiment, the keyboard layer also includes the input field (cross media search bar 202) and the character input candidates (keyword candidate list 278). Since a character input and an input to the search keyword field can be performed in the same layer, the keyword input and search can be performed in a short time.

Next, the function of the defined icon field 219 of the color keys in the top margin of the electronic program guide of FIG. 6 will be described. As described above, various functions are assigned to the color keys of the remote controller 170 according to situations. The color key icons 214, 216, and 218 display the types and/or setting states of the functions assigned during the display of the electronic program guide. The blue color key icon 214 represents a jump. The red color key icon 216 represents a channel mode. The green color key icon 218 represents a view filter. The jump is a function of moving the electronic program guide by a large amount. The channel mode is a function of narrowing down the number of channels to display in the electronic program guide. The view filter is a function of controlling a display mode of the program frames in the electronic program guide based on various types of information.

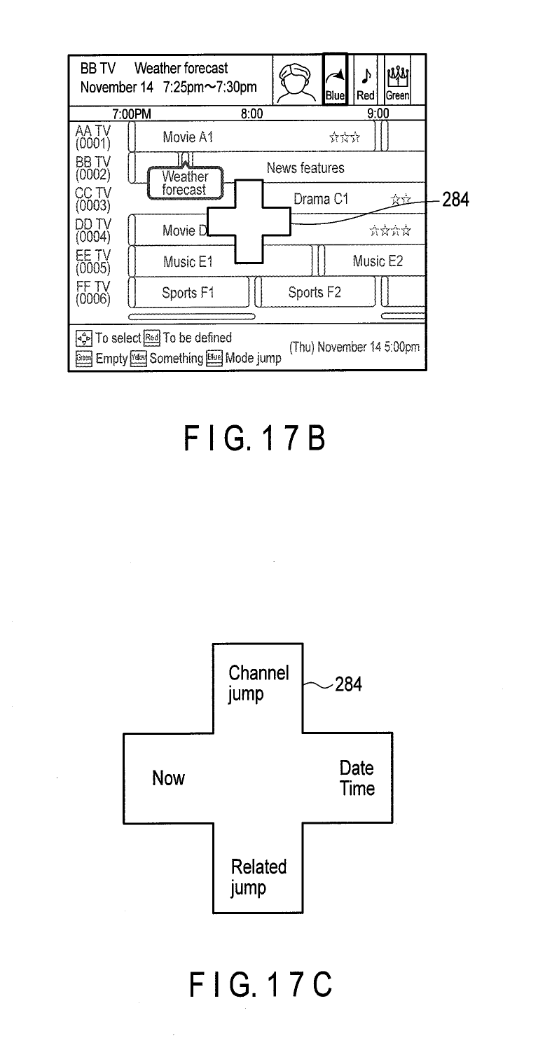

FIGS. 17A to 17C are screen examples when the color key (blue) 64 of the remote controller 170 is pressed during the display of the electronic program guide shown in FIG. 6. FIG. 17A is the same as FIG. 6. When the user wants to move the electronic program guide by a large amount, the user can see from the blue color key icon 214 displaying a jump mark that the blue color key 64 of the remote controller 170 can be pressed. If the blue color key 64 is pressed, a cross key with indications of “now,” “channel jump,” “date and time,” and “related jump” in four directions as shown in FIG. 17C is displayed as shown in FIG. 17B. This means that when the blue color key 64 is pressed, the four directions of the cursor key 62b of the remote controller 170 can select “now,” “channel jump,” “date and time,” and “related jump,” respectively. In such a manner, the blue color key 64 can be pressed to change the functions of the cursor key 62b of the remote controller 170 to the functions of instructing various jumps.

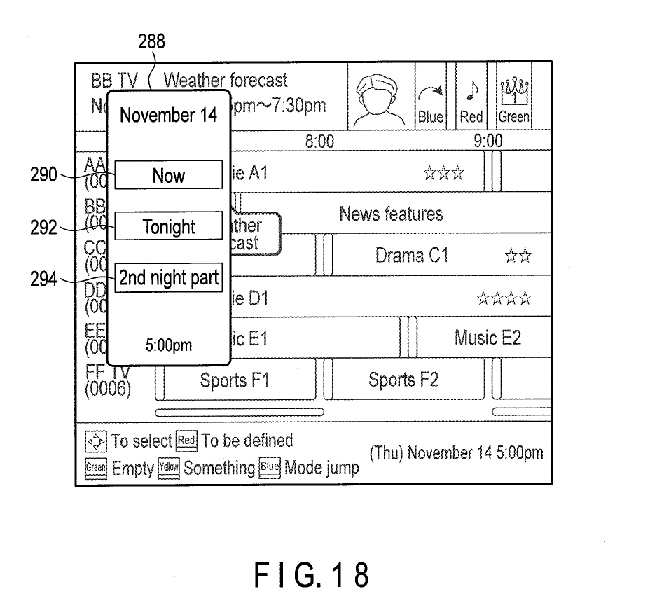

If the left key of the cursor key 62b of the remote controller 170 is pressed in such a state, a current menu 288 such as shown in FIG. 18 is displayed. The current menu 288 includes not only a now button 290 but also a tonight button 292 and a 2nd night part button 294. Any one of the buttons can be selected to jump to the electronic program guide of the selected date.

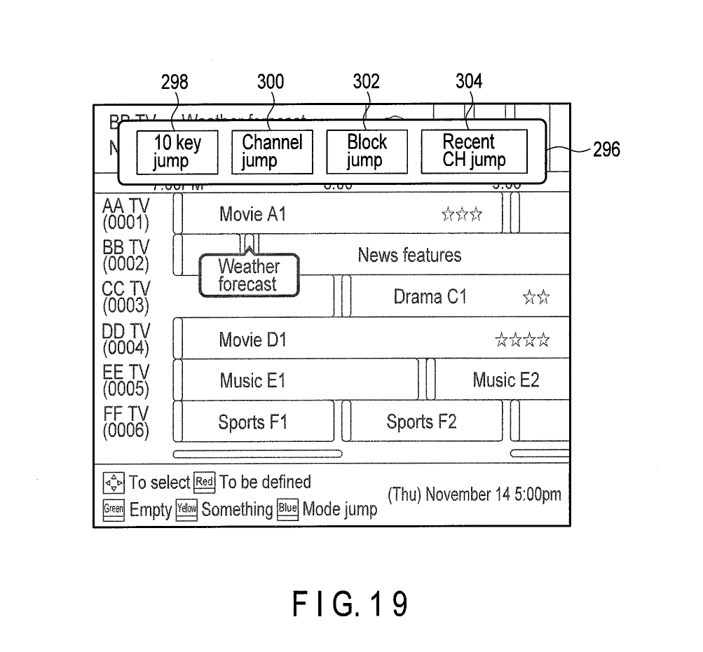

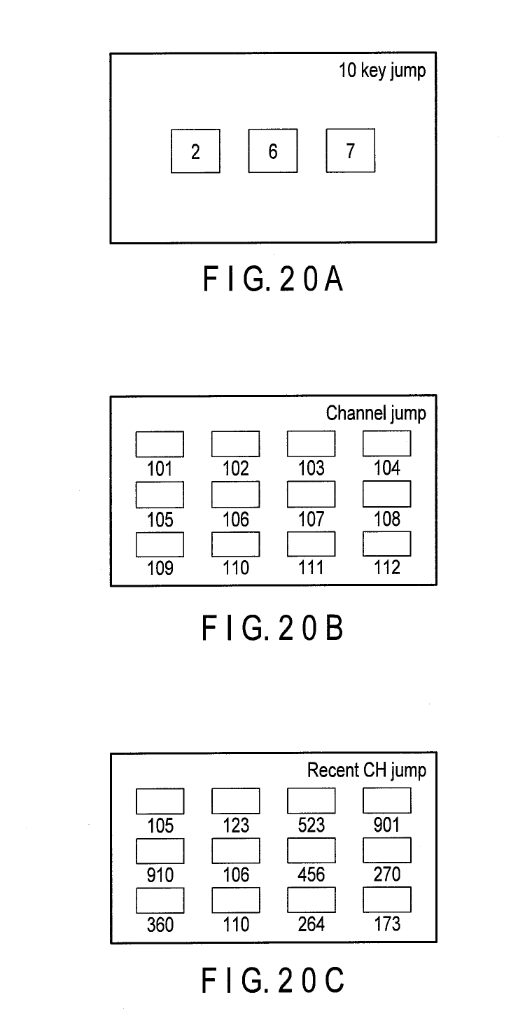

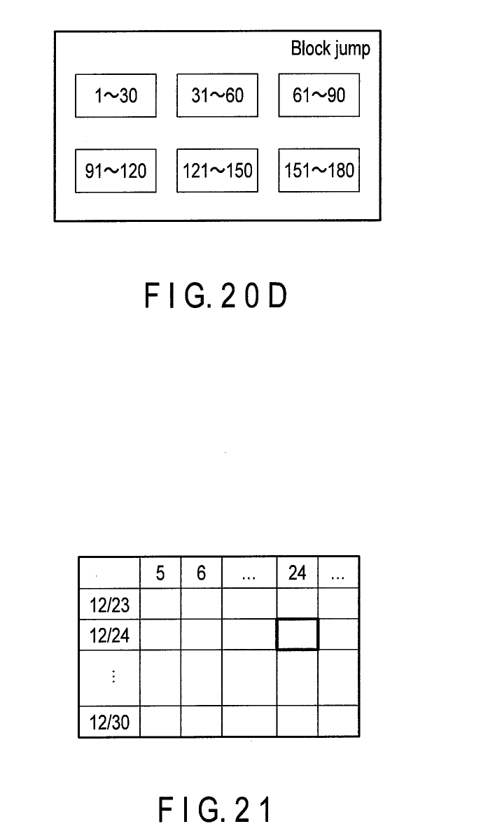

If the up key of the cursor key 62b of the remote controller 170 is pressed, a channel jump menu 296 such as shown in FIG. 19 is displayed. The channel jump menu 296 includes a 10 key jump button 298, a channel jump button 300, a block jump button 302, and a recent cannel jump button 304. Any one of the buttons can be selected. If the 10 key jump button 298 is selected, an input screen of a three-digit channel number such as shown in FIG. 20A is displayed. If the channel jump button 300 is selected, a select screen of channel numbers such as shown in FIG. 20B is displayed. If the recent channel jump button 304 is selected, a screen of recently-viewed channel numbers such as shown in FIG. 20C is displayed. Selecting a program to view based on recently-viewed programs can select a program that matches the user's taste. If the block jump button 302 is selected, a select screen of channel blocks in units of 30 channels such as shown in FIG. 20D is displayed.

If the right key of the cursor key 62b of the remote controller 170 is pressed, a date and time designation menu such as shown in FIG. 21 is displayed. The cursor can be moved to select a date and time and jump to the electronic program guide of the selected date and time.

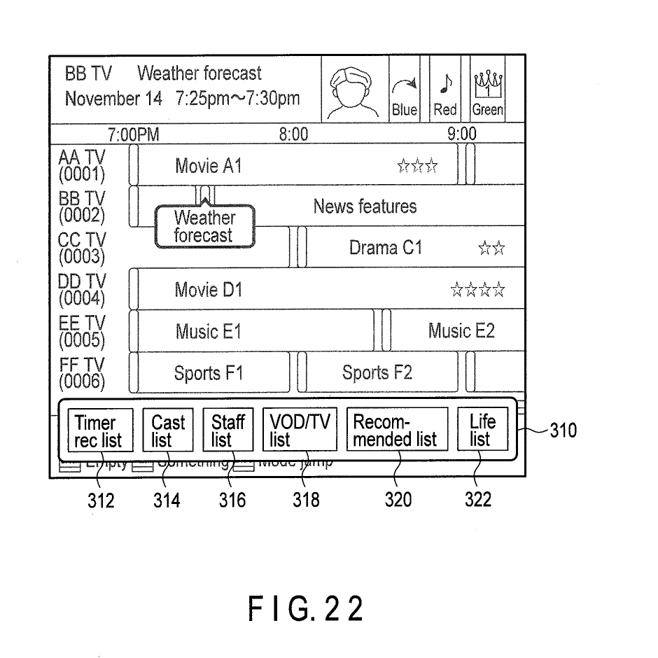

If the down key of the cursor key 62b of the remote controller 170 is pressed, a related program menu 310 such as shown in FIG. 22 is displayed. The related program menu 310 includes a timer recording list button 312, a cast list button 314, a staff list button 316, a VOD/TV list button 318, a recommended list button 320, and a life log list button 322. In such a manner, the related program menu can display lists by “information category” related to a certain program, thereby increasing the diversity of choices.

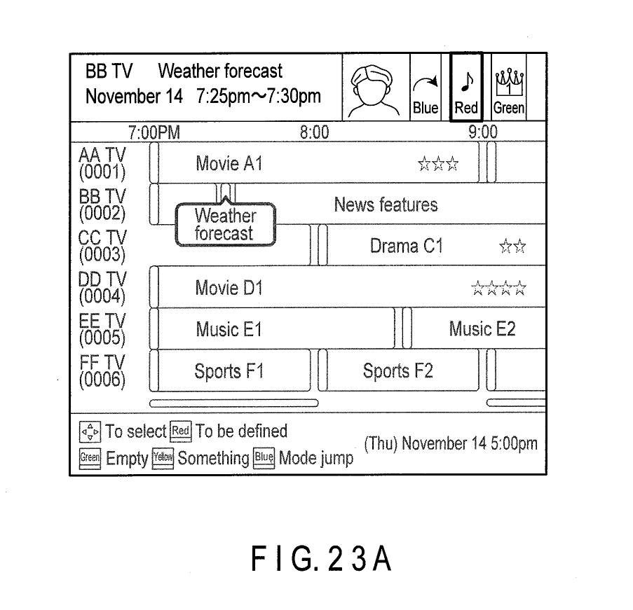

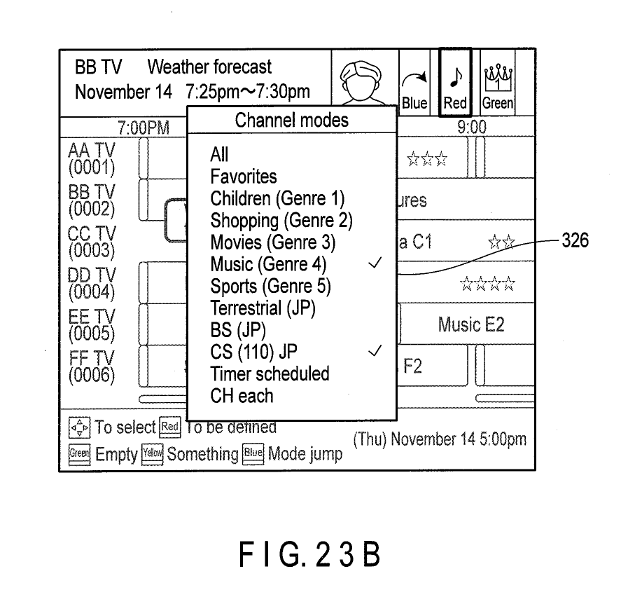

FIGS. 23A and 23B are screen examples when the red color key 66 of the remote controller 170 is pressed during the display of the electronic program guide shown in FIG. 6. FIG. 23A is the same as FIG. 6. A channel mode menu 326 is displayed as shown in FIG. 23B. For example, the channel mode menu 326 displays channel modes such as all, favorites, children (genre 1), shopping (genre 2), movies (genre 3), music (genre 4), sports (genre 5), terrestrial, BS, CS (110), timer scheduled, and channel each. One or a plurality of such modes may be selected. If any of the modes is selected, the red color key icon 216 changes to an icon according to the selected mode. The display of the red color key icon 216 thus shows that the red color key 66 of the remote controller 170 can be pressed to select a channel mode. The display of the red color key icon 216 also shows which mode is currently selected. This can give a hint of multifunctionality to the user. Limiting the channels to display on the electronic program guide to a specific genre(s) and/or type(s) facilitates selecting a program from the electronic program guide.

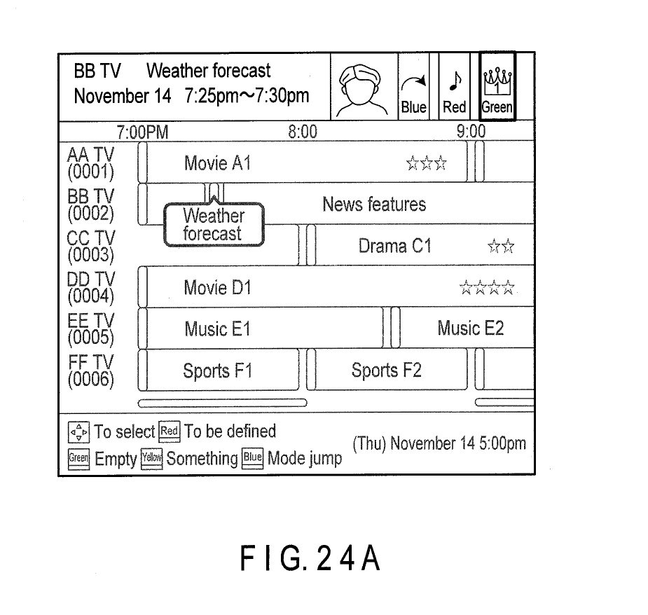

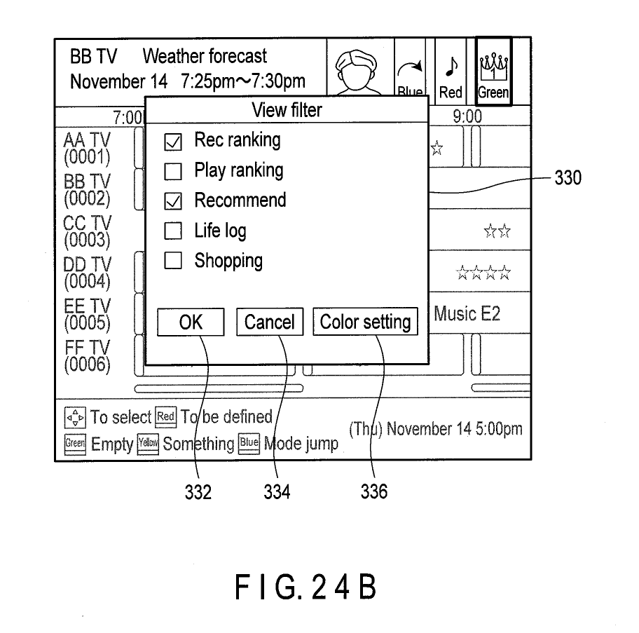

FIGS. 24A and 24B are screen examples when the green color key 68 of the remote controller 170 is pressed during the display of the electronic program guide shown in FIG. 6. FIG. 24A is the same as FIG. 6. A view filter menu 330 is displayed as shown in FIG. 24B. For example, the view filter menu 330 includes alternatives such as recording ranking, play ranking, recommendation, life log, and shopping, and an OK button 332, a cancel button 334, and a color setting button 336. The alternatives are intended to select information for controlling the display mode of program frames in the electronic program guide. One or a plurality of alternatives may be selected. Information about the recording ranking, play ranking, recommendation, life log, shopping, and the like is transmitted from the cloud server 20.

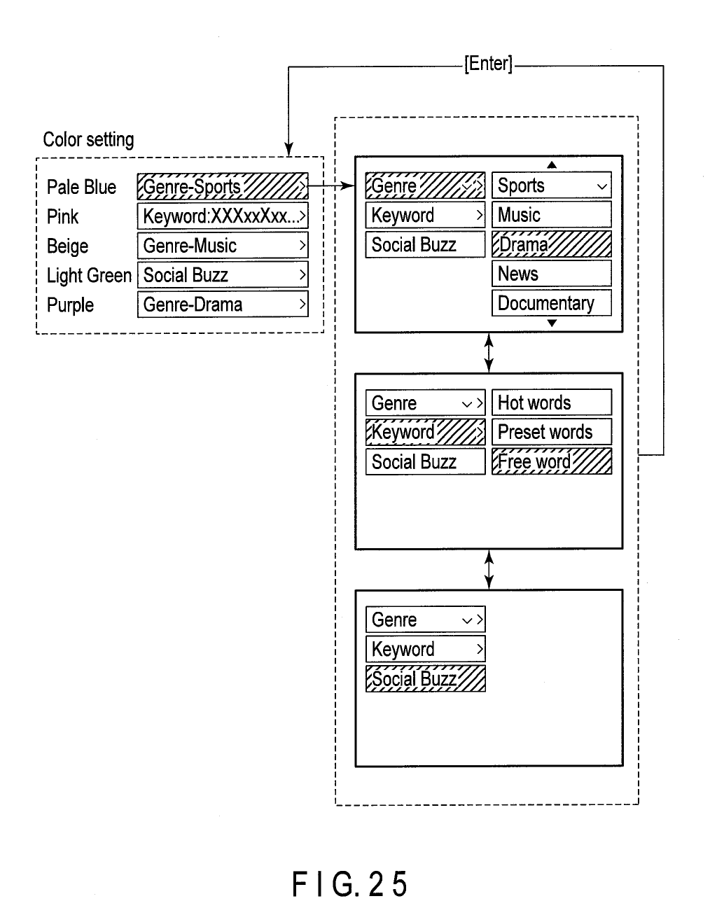

If the color setting button 336 is selected, a menu that can set the display mode (color, icon, etc.) of the selected information is displayed as shown in FIG. 25. As employed herein, the display colors of the program frames are set as follows. Pale blue indicates a sport genre, pink program frames including a predetermined keyword, beige a music genre, light green a social buzz, a purple violet a drama genre. Since the display colors of the program frames can be set based on various types of information, the electronic program guide can be customized according to the user's preferences for improved user convenience. The program frames themselves may be colored. As shown in FIG. 7, the color bar 224 displayed at the head of the frame before the program name of the program frame 222 may be changed in color.

Table 3 shows another example of the color settings of the view filter. Table 3 shows an example where icons can be set aside from colors. An icon level refers to the number of star marks, for example. The number of star marks varies with ranking.

TABLE 3

| | |
|---|---|
| Genre A | Color set 1 |
| Genre B | Color set 1 |
| Genre C | Color set 1 |
| Genre D | Color set 1 |
| Genre E | Color set 1 |
| Rec ranking | Icon by 3 to 5 levels |
| Play ranking | Icon by 3 to 5 levels |
| Recommend | Icon |
| Social Buzz | Color set 2 |
| Lifelog | Icon & color |
| (timer scheduled current device) | |
| Lifelog | Icon & color |
| (timer scheduled other devices) | |
| Lifelog (watched) | Icon |
| Lifelog (can play) | Icon |
| Lifelog (recorded before) | Icon |
| Lifelog (similar watched) | Icon |
| Shopping (BD/DVD) | Icon |
| Keyword (show included) | Color set 3 |

The social buzz is intended to identifiably display programs that are much talked about on the Internet 18. The user can select buzz types. For example, the user can switch to display only “recommendation” marks without displaying social buzzes.

In another example, a shopping mode, programs with a favorite keyword, programs much talked about, and the like may be identifiably displayed. Colors may be used based on the presence or absence of information, not genres. Colors and icons may be used to identifiably display arbitrary information (other than conventional genres). A social buzz matrix may be displayed as marks in the program frames of the program guide. Only programs including a favorite keyword may be displayed in a different mode in the program guide.

As has been described above, according to the first embodiment, the screen layout remains unchanged when the electronic program guide is relationally searched for persons, programs, and the like. For example, the area of the program information is arranged above the display area of the main body of the program guide. Even if searches advance like something related to something related to . . . and so on, the display of the area of the program information field remains unchanged unless the program changes. Consequently, the user can always recognize the originating program based on which he/she is performing a search. This enables searches in units of programs with high user-friendliness.

The software keyboard to be operated by the cursor for the purposes of inputting search characters and the like is displayed as superposed on a menu or other screen. Since the search character input field and the like are also arranged in the display layer of the software keyboard, the cursor can be freely moved between the software keyboard and the search character input field with excellent operability.

Multiple functions can be assigned to the keys of the remote controller. Key icons indicating which functions are currently assigned and the setting states of the functions are displayed, for example, on the upper right of the screen. This can give a hint of multifunctionality to the user.

Moreover, since the display mode (view) of the electronic program guide is changed according to various conditions, or various types of information is identifiably displayed, an appropriate display control can be performed user by user even if the types of the contents increase.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a first display controller configured to display a program guide in a first area of a screen and program information about a program in a second area of the screen;
a second display controller configured to display, in the first area, detailed information of the program information displayed in the second area; and
a third display controller configured to, when detailed information about another program or another title is displayed in the first area, display program information about the other program or the other title in the second area.

2. The apparatus of claim 1, further comprising a search module configured to search for person information related to the detailed information displayed in the first area, wherein
the second display controller is configured to display a search result of the search module in the first area.

3. The apparatus of claim 1, wherein the detailed information displayed in the first area comprises a thumbnail of the program or a summary of the program.

4. The apparatus of claim 1, further comprising a fourth display controller configured to display an icon in a third area of the screen, the icon indicating a function assigned to a multifunctional key of a remote controller and a setting status of the function.

5. The apparatus of claim 1, wherein the first display controller is configured to display a program guide of a channel of a predetermined genre in the first area.

6. The apparatus of claim 1, wherein the first display controller is configured to display each program frame of the program guide in different modes according to an attribute of the program.

7. An information processing method comprising:
a first display control step of displaying a program guide in a first area of a screen and displaying program information about a program in a second area of the screen;
a second display control step of displaying, in the first area, detailed information of the program information displayed in the second area; and
a third display control step of, when detailed information about another program or another title is displayed in the first area, displaying program information about the other program or the other title in the second area.

8. The method of claim 7, further comprising searching for person information related to the detailed information displayed in the first area, wherein a search result of the search module is displayed in the first area.

9. The method of claim 7, wherein the detailed information displayed in the first area comprises a thumbnail of the program or a summary of the program.

10. The method of claim 7, further comprising displaying an icon in a third area of the screen, the icon indicating a function assigned to a multifunctional key of a remote controller and a setting status of the function.

11. The method of claim 7, wherein a program guide of a channel of a predetermined genre is displayed in the first area.

12. The method of claim 7, wherein each program frame of the program guide is displayed in different modes according to an attribute of the program.

13. A non-transitory computer-readable storage medium storing computer-executable instructions that, when executed, cause a computer to:
display a program guide in a first area of a screen and displays program information about a program in a second area of the screen;
display, in the first area, detailed information of the program information displayed in the second area; and
display, when detailed information about another program or another title is displayed in the first area, program information about the another program or the another title in the second area.

14. The storage medium of claim 13, wherein person information related to the detailed information displayed in the first area is searched for, and a search result of the search module is displayed in the first area.

15. The storage medium of claim 13, wherein the detailed information displayed in the first area comprises a thumbnail of the program or a summary of the program.

16. The storage medium of claim 13, wherein an icon is displayed in a third area of the screen, the icon indicating a function assigned to a multifunctional key of a remote controller and a setting status of the function.

17. The storage medium of claim 13, wherein a program guide of a channel of a predetermined genre is displayed in the first area.

18. The storage medium of claim 13, wherein each program frame of the program guide is displayed in different modes according to an attribute of the program.
